(19) United States
(12) Patent Application Publication
(10) Pub. No.: US 2003/0038846 A1
(43) Pub. Date: Feb. 27, 2003

(54) Message display program and message display apparatus

(75) Inventors: Tetsuya Hori, Tokyo (JP); Yoshifumi Sanuki, Tokyo (JP); Haruna Ishii, Tokyo (JP); Masatoshi Yamazaki, Tokyo (JP); Kazumi Maruyama, Tokyo (JP); Tomoyuki Suzuki, Tokyo (JP); Takuya Yamada, Kawasaki (JP); Kazuhiro Koide, Ishikawa (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/100,904

(22) Filed: Mar. 20, 2002

(30) Foreign Application Priority Data
Aug. 27, 2001 (JP) 2001-256317

(51) Int. Cl. G09G 5/00

(52) U.S. Cl. 345/809

(57) ABSTRACT

There are provided a message display program and a message display apparatus which, if a command corresponding to an object cannot be executed, are capable of notifying the user of a precondition for making the command executable. The message display program has an object management table in which each object associated with a respective predetermined command is associated beforehand with an execution-permitting condition which is a precondition for executing the command. When the object displayed is selected by an operating input, the message display program causes a computer to look up the execution-permitting condition associated with the selected object to determine whether or not the execution-permitting condition is satisfied. When it is determined that the execution-permitting condition is not satisfied, the message display program causes the computer to display an input aid message associated beforehand with the execution-permitting condition.

### BACKGROUND OF THE INVENTION

1. Field of the Invention

This invention relates to a message display program and apparatus for displaying a message on a screen, and more particularly to a message display program and apparatus for displaying a message related to an object displayed by a Graphical User Interface (GUI).

2. Description of the Related Art

At present, most computers are operated by operating systems (OSes) incorporating a GUI. In the GUI, objects associated with respective commands are displayed on a screen. The objects of this kind include a menu command or an icon, for instance. A user operates a pointer (also called a mouse cursor) on the screen by using a pointing device, such as a mouse or the like, and can designate an object indicated by the pointer (e.g. by depressing a button of the mouse) to thereby input a command to the computer.

Some of the commands corresponding to the menu commands and icons displayed on the screen of the GUI cannot be executed to perform effective processing unless a predetermined condition is satisfied. For instance, a copy command (command for storing a copy of a selected object in a memory) cannot be executed unless an object or a character string to be copied is selected.

In most of recent GUIs, menu commands or icons corresponding to non-executable commands are set in an unselectable state. The unselectable menu commands or icons are grayed out (shown in a color similar to the background color). This enables the user to recognize that the menu commands or icons cannot be selected.

Further, menu commands or icons corresponding to non-executable commands can be set in a selectable state and an error (warning) message is displayed when such a menu command or icon is selected. In such a case, the user can recognize that the command is not executable, by viewing the error message.

Thus, the user is notified of the non-executable state of some commands corresponding to respective menu commands or icons displayed on the screen. The user aware of this fact performs an operating input (i.e. operation for inputting) to a computer to change the state of the computer such that the precondition for executing the command is satisfied, and then selects the menu command or icon, whereby the corresponding command can be executed.

However, even if a menu command or icon is grayed out or an error message is displayed upon selection of an unselectable menu command or icon, to explicitly show that the corresponding command cannot be executed, it is impossible for the user to understand the reason why the command is not executable. Although description of an icon or the like is displayed at a location close to the same by popup help, the conventional popup help only explains the function of a command. Therefore, if the user is not accustomed to such software, it is difficult to understand a precondition for executing the command only by viewing the popup help.

Therefore, when it is impossible for the user to perform a command corresponding to a menu command or an icon, the user has to find the cause of the impossibility. One method of finding the cause is to display an online manual on the screen, read description of the command, and grasp a precondition for executing the command. Then, the user performs an operating input for satisfying the precondition to the computer.

However, most part of the online manual is difficult to understand for the user unaccustomed to the software, and hence it takes much time for him to find a desired description (as to what is the precondition for executing the command). In some worse cases, the precondition is not clearly described in the online manual and the user has to cope with the situation by the trial-and-error method.

As described above, to make executable such a command corresponding to a menu command or an icon, the user who is not accustomed to the software to be operated has to spend much time in cause-finding operations, such as consulting of manuals. This causes serious or long interruption of the main or intended operation.

### SUMMARY OF THE INVENTION

The present invention has been made in view of these circumstances, and an object thereof is to provide a message display program and a message display apparatus which are capable of notifying the user of a precondition for making a command corresponding to an object executable, when the command is not executable.

To attain the above object, there is provided a message display program for displaying a message on a screen. The message display program is characterized by causing a computer to execute the processes of looking up an execution-permitting condition, when an object associated with a predetermined command is displayed and selected by an operating input, the object being associated beforehand with the execution-permitting condition which is a precondition for executing the command, and determining whether or not the execution-permitting condition is satisfied, and displaying an input aid message associated beforehand with the execution-permitting condition when it is determined that the execution-permitting condition is not satisfied.

Further, to attain the above object, there is provided a message display apparatus for displaying a message on a screen. The message display apparatus is characterized by comprising an object management table defining a correspondence between each object associated with a respective predetermined command and an execution-permitting condition which is a precondition for executing the command, and a correspondence between the execution-permitting condition and an input aid message, determination means which, when the object displayed is selected by an operating input, looks up the object management table to determine whether or not the execution-permitting condition associated with the selected object is satisfied, and display means for displaying the input aid message associated with the execution-permitting condition in the object management table when it is determined by the determination means that the execution-permitting condition is not satisfied.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram useful in explaining operating principles of the present invention;

FIG. 2 is a diagram schematically showing examples of display screens displayed by a process according to the invention;

FIG. 3 is a diagram showing the arrangement of a system to which is applied the embodiment of the invention;

FIG. 4 is a block diagram showing an example of the hardware configuration of a client computer;

FIG. 5 is a block diagram showing functional blocks illustrating functions of the client computer;

FIG. 6 is a diagram showing an example of a menu management table;

FIG. 7 is a flowchart showing how a menu screen display process is carried out;

FIG. 8 is a flowchart showing how a message display process is carried out;

FIG. 9 is a diagram showing an example of a server management screen with a menu screen displayed therein;

FIG. 10 is a diagram showing another example of the server management screen with a primary node-setting screen displayed therein;

FIG. 11 is a diagram showing another example of the server management screen with a secondary node-setting screen displayed therein; and

FIG. 12 is a diagram showing an example of the server management screen with a representative address-setting screen displayed therein.

### DESCRIPTION OF THE PREFERRED EMBODIMENT

The invention will now be described in detail with reference to drawings showing a preferred embodiment thereof.

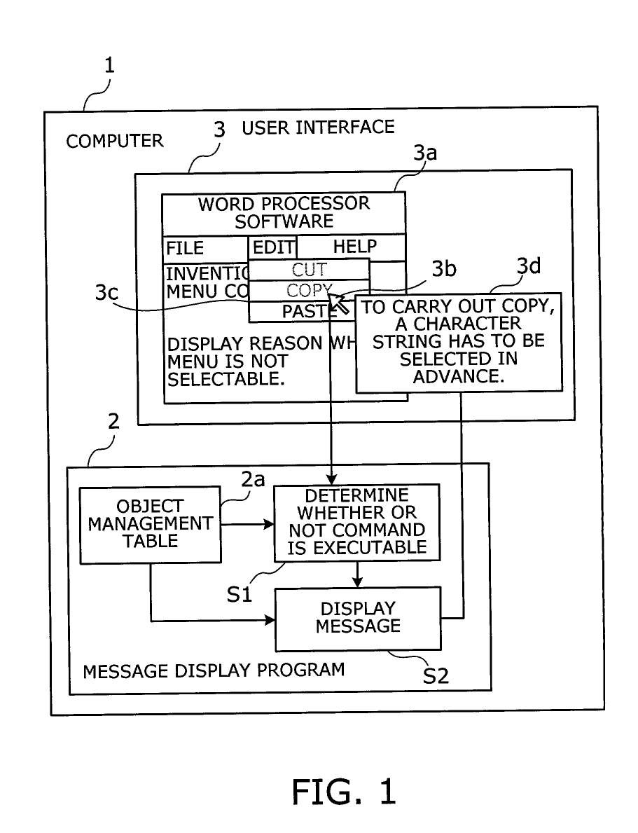

FIG. 1 is a block diagram showing the operating principles of the present invention. A message display program 2 according to the invention is installed in a computer 1, for causing the computer 1 to perform predetermined functions. The computer 1 carries out the message display program 2 whereby it functions as a message display apparatus. Further, the computer 1 has a user interface 3 installed therein in addition to the message display program 2.

The user interface 3 is a processing function realized by a program for GUI (Graphical User Interface) executed by the computer 1. The user interface 3 displays a screen 3a based on an application software, such as word processor software. The user interface 3 displays an object 3c associated with a command in the screen 3a. The object 3c is a command menu, for instance. The user interface 3 controls the movement of the pointer 3b in response to an operating input (i.e. operation for inputting). Further, if an operating input is performed to select an object located at a position indicated by the pointer 3b, the user interface 3 notifies the inputted information to a processing function realized by the message display program 2.

The message display program 2 has an object management table 2a which stores objects associated with predetermined commands, and execution-permitting conditions as preconditions for carrying out the respective commands, such that the objects and the conditions therefor are associated with each other in advance. Further, the object management table 2a stores input aid messages in a manner associated with the execution-permitting conditions. Each input aid message is formed by a character string which describes, for instance, a cause or a reason why it is impossible to perform a command, or an operating procedure required to satisfy an execution-permitting condition for performing the command. Further, the object management table 2a stores function tutorial messages associated with the respective objects and describing functions of the commands associated with the objects. Each function tutorial message is formed by a character string describing effects or results of execution of the associated command.

If an object 3c displayed by the user interface 3 is selected by an operating input, the message display program 2 causes the computer 1 to look up an execution-permitting condition associated with the selected object 3c and determine whether or not the execution-permitting condition is satisfied for performing the object 3c, at a step S1. Here, the operation for selecting the object 3c is an operation for moving the pointer 3b to the position of the object 3c.

If it is determined that the execution-permitting condition is not satisfied, at a step S2, the message display program 2 causes the computer 1 to display an input aid message 3d associated beforehand with the execution-permitting condition, whereas if it is determined that the execution-permitting condition is satisfied, it causes the computer 1 to display a function tutorial message associated beforehand with the object 3c. The input aid message 3d and the function tutorial message are displayed e.g. at a location close the pointer 3b.

As described above, according to the message display program 2, when the object 3c displayed on the computer 1 is selected by an operating input, if the execution-permitting condition for carrying out the object 3c is not satisfied, the input aid message 3d is displayed, whereas if the execution-permitting condition is satisfied, the function tutorial message is displayed.

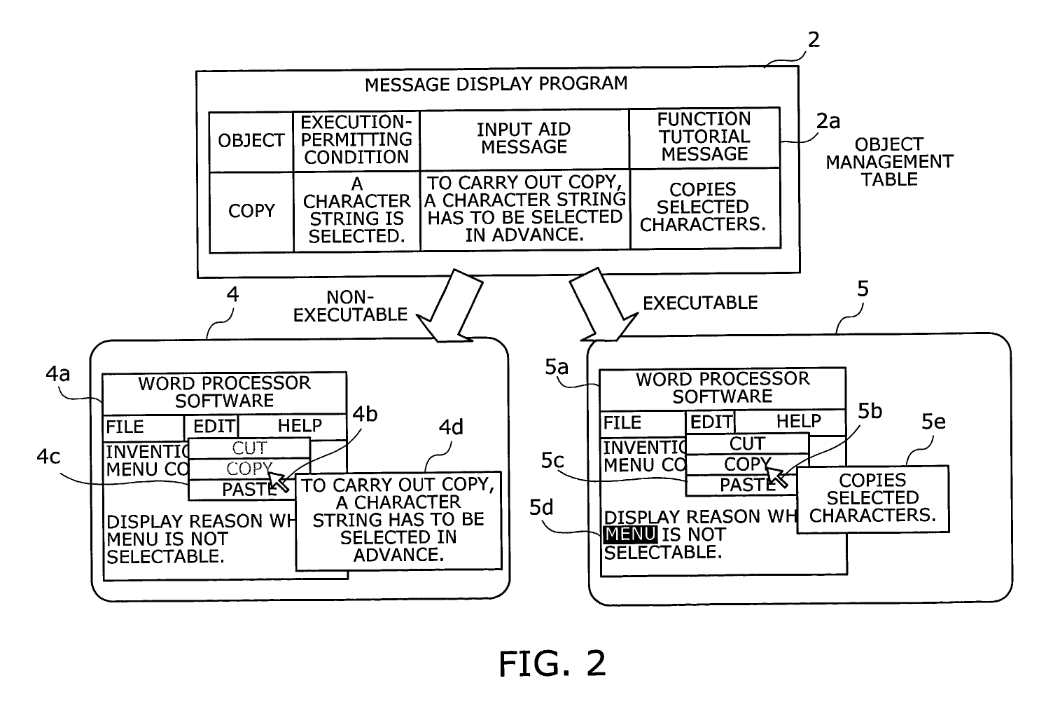

FIG. 2 schematically shows how the message display process according to the invention is carried out on a display screen. The illustrated example shows cases in which a message associated with a copy command in word processor software is displayed. In the illustrated example, it is assumed that the object management table 2a stores an execution-permitting condition, an input aid message, and a function tutorial message, concerning a menu command (named “COPY”) associated with the copy command. The execution-permitting condition is that “A character string is selected.”. The input aid message is “To carry out COPY, a character string has to be selected in advance.”. The function tutorial message is “Copies selected characters.”.

Now, as shown in a screen 4, if the user moves the pointer 4b to the menu command 4c “COPY” displayed in an application screen 4a without selecting a character string to be copied, the execution-permitting condition is not satisfied (the command is not executable). In this case, an input aid message 4d is displayed on the screen 4.

Further, as shown in a screen 5, when the user moves the pointer 5b to the menu command 5c “COPY” displayed in the application screen 5a after having selected the character string 5d to be copied, the execution-permitting condition is satisfied (the command is executable). In this case, a function tutorial message 5e is displayed on the screen 5.

As described above, according to the present invention, if a command cannot be executed when an object associated with the command is selected, a cause or a reason for why the command is not executable is displayed. This enables the user to easily understand what operation needs to be carried out so as to make the command executable. For instance, in the examples illustrated in FIG. 2, when the user views the input aid message 4d, he can easily understand that he has to select the character string to be copied before carrying out the copy command.

This saves the user from taking the trouble of finding the cause of impossibility of execution of the command by consulting on an online manual or the like, thereby enhancing the efficiency of operation carried out by using the computer 1.

The present invention can be applied to all systems using the GUI. Moreover, the present invention is very useful when software necessitates advanced technical skill or knowledge in using the same, especially with a view to preventing erroneous operating inputs. Therefore, the embodiment will be described in detail hereinafter based on an example in which the present invention is applied to software for managing a server via a network.

It should be noted that in the following embodiment, an object associated with a non-executable command is set to an unselectable state. Therefore, in the following description of the embodiment, “an execution-permitting condition” is translated into “a selection-permitting condition”. Further, “determination as to whether or not a command is executable” is translated into “determination as to whether or not an object is selectable”.

Further, in the following embodiment, the operation for selecting an object includes an operation for causing a message to be displayed by popup help, and an operation for causing execution of a command corresponding to the object. In the following description, the selection of an object for causing a message to be displayed is referred to as provisional selection.

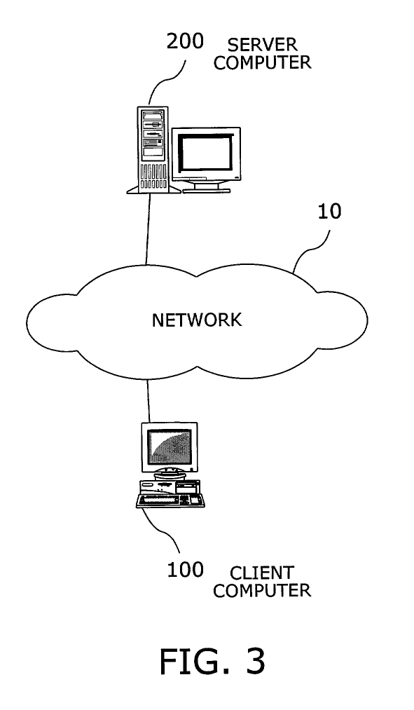

FIG. 3 shows the arrangement of a system to which is applied the present embodiment of the invention. In the present embodiment, a client computer 100 and a server computer 200 are connected to each other via a network 10. The client computer 100 has a program to which is applied the present invention installed therein. The server computer 200 provides various processing functions via the network 10.

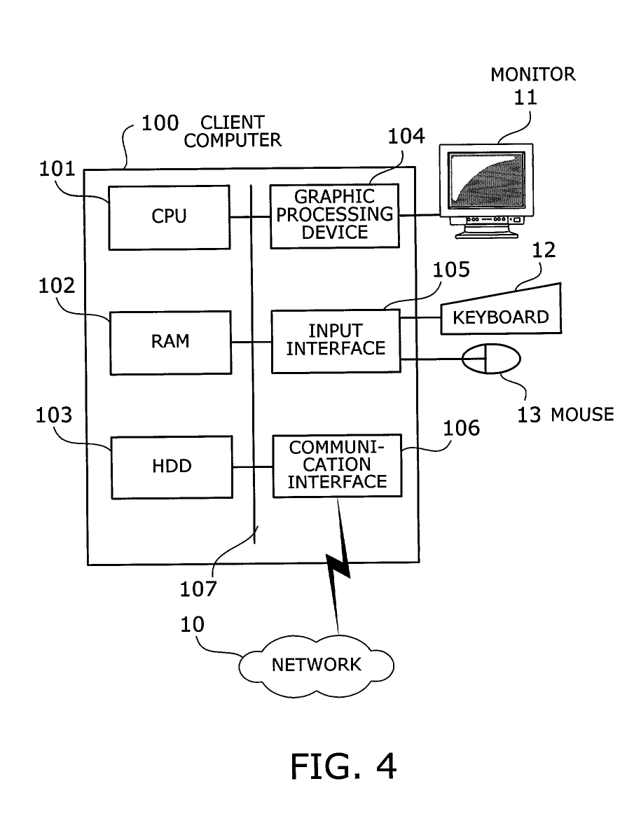

FIG. 4 shows an example of the hardware configuration of the client computer 100. The client computer 100 has the overall operation thereof controlled by a CPU (Central Processing Unit) 101. Connected via a bus 107 to the CPU 101 are a RAM (Random Access Memory) 102, an HDD (Hard Disk Drive) 103, an graphic processing device 104, an input interface 105, and a communication interface 106.

The RAM 102 temporarily stores at least part of the programs of an OS (Operating System) and application programs, executed by the CPU 101. The RAM 102 further stores data necessary for processing by the CPU 101. The HDD 103 stores the OS and application programs.

The graphic processing device 104 is connected to a monitor 11. The graphic processing device 104 causes an image to be displayed on a screen of the monitor 11 in accordance with an instruction from the CPU 101. The input interface 105 is connected to a keyboard 12 and a mouse 13 and transmits a signal delivered from the keyboard 12 or the mouse 13 to the CPU 101 via the bus 107.

The communication interface 106 is connected to the network 10, and transmits and receives data to and from another computer via the network 10.

The processing functions of the present embodiment can be realized by the above configuration of the hardware.

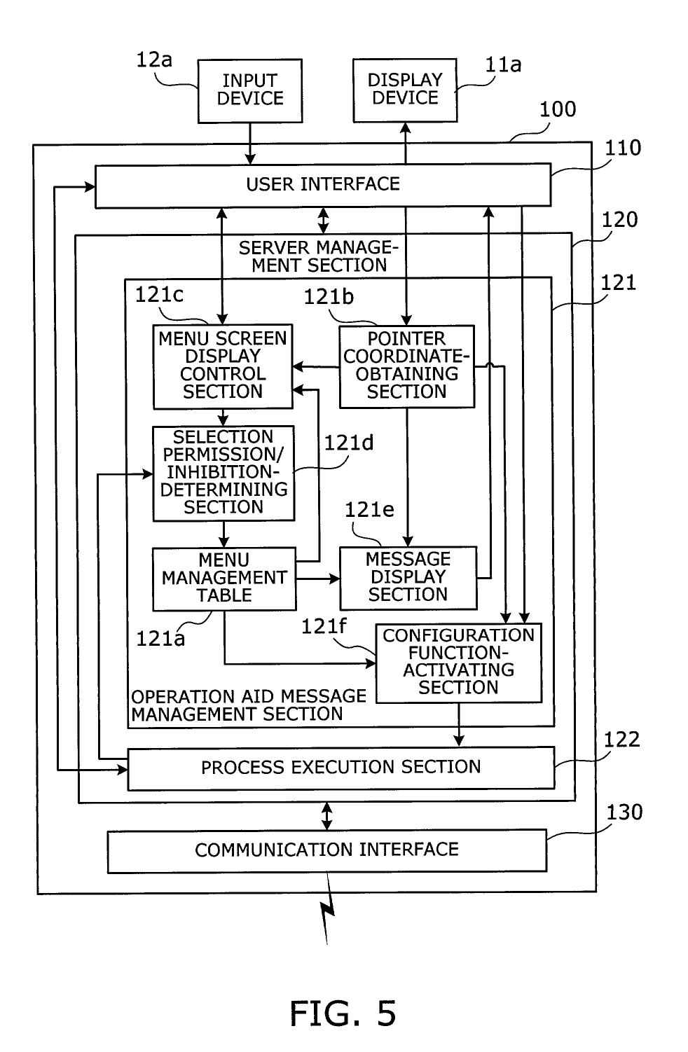

FIG. 5 is a block diagram showing functional blocks of the client computer 100. Connected to the client computer 100 are a display device 11a and an input device 12a. The display device 11a represents a function implemented by the monitor 11 shown in FIG. 4. The input device 12a represents a function implemented by the keyboard 12 and the mouse 13 shown in FIG. 4.

The client computer 100 is largely comprised of a user interface 110, a server management section 120, and a communication interface 130.

The user interface 110 provides the functions of the GUI via the input device 12a and the display device 11a. More specifically, the user interface 110 causes menu commands, icons, and a pointer to be displayed on a screen of the display device 11a. The user interface 110 moves the pointer on the screen, in response to an input from the input device 12a, and passes position information of the pointer and information of provisional selection or selection by an operating input, to the server management section 120.

The server management section 120 carries out the management and maintenance of the server computer 200 via the network 10. An operation aid message management section 121 includes a menu management table 121a, a pointer coordinate-obtaining section 121b, a menu screen display control section 121c, a selection permission/inhibition-determining section 121d, a message display section 121e, and a configuration function-activating section 121f.

The menu management table 121a stores selection-permitting conditions which are preconditions for causing commands associated with respective menu commands to be executed. Further, the menu management table 121a stores character strings (function tutorial messages) each displayed when a selection-permitting condition for executing a corresponding command is satisfied, and character strings (input aid messages) each displayed when the selection-permitting condition is not satisfied. Further, the menu management table 121a stores information of screens for inputting settings required for satisfying the respective selection-permitting conditions.

The pointer coordinate-obtaining section 121b obtains the coordinates of a pointer from the user interface 110 when a menu screen is open. It should be noted that the coordinates of the pointer obtained from the user interface 110 are coordinates determined with reference to the upper left corner of a screen being currently active or selected for manipulation.

The menu screen display control section 121c displays a menu screen presenting a list of menu commands. The menu screen is displayed e.g. when a command, such as “FILE”, “EDIT” or the like, is selected which is displayed in a tool bar arranged in an execution screen of an application program. Further, the menu screen is displayed also when a predetermined operation (such as a click of the right button of the mouse) is carried out in a state in which an object displayed on the screen is selected.

Upon reception of information input by user's operation via the input device from the user interface 110, the menu screen display control section 121c receives information of the coordinates of the pointer from the pointer coordinate-obtaining section 121b. Then, the menu screen display control section 121c causes the menu screen corresponding to the object located at the position indicated by the pointer, to be displayed on the display device 11a by the user interface 110. At the same time, the menu screen display control section 121c requests the selection permission/inhibition-determining section 121d to determine whether or not each of the menu commands is selectable. Then, the menu screen display control section 121c looks up the menu management table 121a and displays the menu commands in a fashion dependent the results of the determination by the selection permission/inhibition-determining section 121d.

The menu screen display control section 121c displays selectable menu commands in a clear form on the menu screen. For instance, the selectable menu commands are displayed in black letters on a white background. On the other hand, the menu screen display control section 121c displays unselectable menu commands in an unclear form. For instance, the unselectable menu commands are displayed in gray letters on the white background (grayed out).

When the menu screen is opened, responsive to the request from the menu screen display control section 121c for determining whether or not each of the menu commands is selectable, the selection permission/inhibition-determining section 121d determines whether or not a selection-permitting condition for performing the menu command is satisfied, by checking the information of settings of the client computer 100, the operating conditions of the client computer 100 and the server computer 200, and so forth.

If there are a plurality of selection-permitting conditions, the selection permission/inhibition-determining section 121d determines whether or not each of the selection-permitting conditions is satisfied. The determination is carried out on each menu command, and if all the selection-permitting conditions for the menu command are satisfied, the menu command is determined to be selectable, whereas if at least one of the selection-permitting conditions for the menu command is not satisfied, the menu command is determined to be unselectable. The selection permission/inhibition-determining section 121d sets the results of the determinations in the menu management table 121a.

Further, when settings, such as parameters, are changed by a process execution section 122, the selection permission/inhibition-determining section 121d determines again according to the changed settings whether or not the selection-permitting condition(s) for each menu command in the menu screen displayed is/are satisfied. Then, the selection permission/inhibition-determining section 121d passes the results of the re-determinations to the menu screen display control section 121c and at the same time sets them in the menu management table 121a.

The message display section 121e receives the coordinates of the pointer from the pointer coordinate-obtaining section 121b, and looks up the menu management table 121a if the coordinates have not been shifted for a predetermined time period (e.g. one second). Further, based on the contents of the menu management table 121a, the message display section 121e determines that the menu command is provisionally selected if there is a menu command corresponding to a position indicated by the pointer, and looks up the menu management table 121a to determine whether or not the selection-permitting condition for performing the menu command provisionally selected is satisfied.

Next, the message display section 121e obtains a message dependent on the selectable or unselectable state of the menu command provisionally selected, from the menu management table 121a, and displays the message at a location close to the menu command. More specifically, if the menu command provisionally selected is selectable, a function tutorial message describing a function to be executed based on the command corresponding to the menu command is displayed, whereas if the menu command provisionally selected is not selectable, an input aid message describing information of settings necessary for making the menu command selectable is displayed.

While the input aid message is being displayed, the configuration function-activating section 121f receives information entered by an operating input (e.g. a click of the left button of the mouse), via the user interface 110, and then looks up the menu management table 121a to pass an activation request for activating a setting function necessary for making the menu command selectable, to the process execution section 122.

It should be noted that if there are a plurality of setting functions required to be activated for making the menu command selectable, whenever a setting process by one setting function is completed, the configuration function-activating section 121f sequentially outputs an activation request for activating another setting function. After completion of setting processes by all the setting functions required for making the menu command selectable, the configuration function-activating section 121f outputs an execution request for executing the command associated with the menu command (processing request for execution of the process corresponding to the command) to the process execution section 122.

The process execution section 122 carries out substantial processing for remote control of the server. Processing operations carried out by the process execution section 122 include execution of functions for setting parameters and the like. The process execution section 122 receives, via the user interface 110, information entered by an operating input from the input device 12a, and executes various processing operations based on the information. Further, responsive to each activation request from the configuration function-activating section 121f for activating a corresponding setting function, the process execution section 122 activates the setting function.

The communication interface 130 transmits information delivered from the server management section 120 to the server computer 200 and at the same time passes information sent from the server computer 200 to the server management section 120.

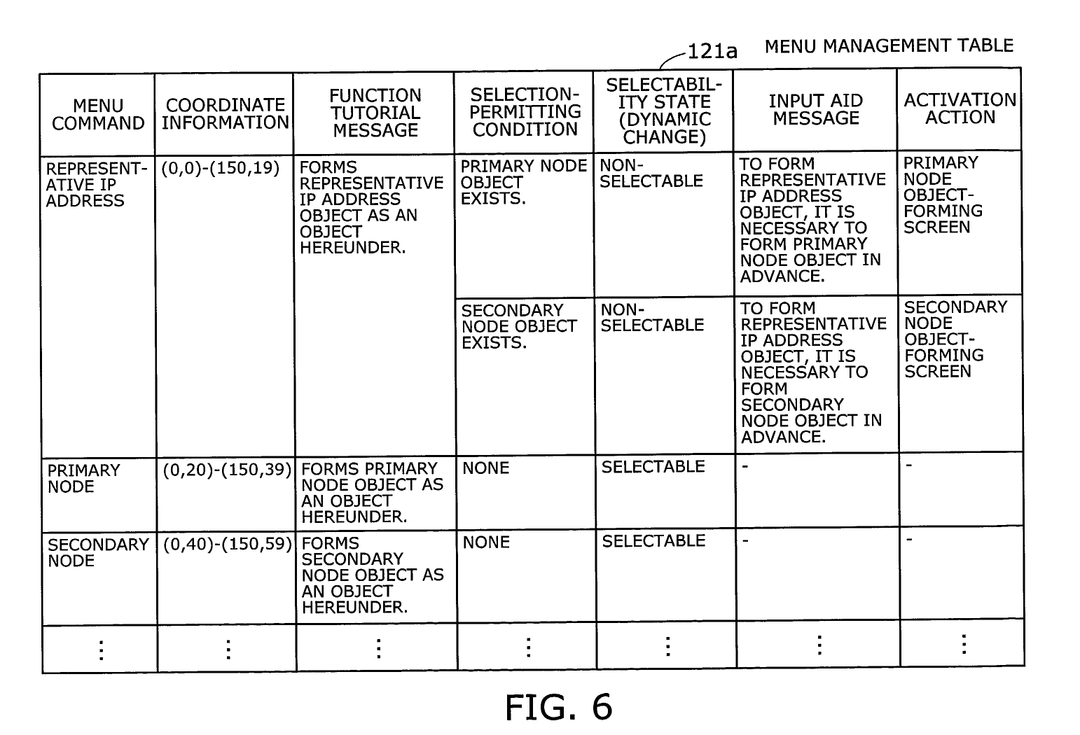

FIG. 6 shows an example of the menu management table 121a. The menu management table 121a contains the columns of “Menu Command”, “Coordinate Information”, “Function Tutorial Message”, “Selection-Permitting Condition”, “Selectability State (Dynamic Change)”, “Input aid message”, and “Activation Action”.

The column of “Menu Command” stores menu commands contained in a menu screen. The illustrated example shown in FIG. 6 stores “Representative IP Address”, “Primary Node”, “Secondary Node”, and so forth.

The column of “Coordinate Information” stores respective sets of coordinates indicative of display ranges within each of which a menu command is displayed, such that the sets of coordinates are associated with the menu commands, respectively. The display range of each menu command has a rectangular shape, and is defined by an upper left corner position and a lower right corner position thereof. The positions defining the display range of each menu command are indicated based on the X-Y coordinate system with the upper left corner of the menu screen being set to a reference position (origin). A downward direction is a positive direction along the X axis, and a rightward direction is a positive direction along the Y axis. Distances from the origin are expressed in the number of dots in a display image.

In the illustrated example shown in FIG. 6, coordinates “(0, 0)-(150, 19)” are set in the column of “Coordinate Information” such that they are associated with the menu command of “Representative IP Address”. The first coordinates (0, 0) represent the upper left corner position of a display range of the menu command (0 dots along the X axis and 0 dots along the Y axis, from the origin), and the next coordinates (150, 19) represent the lower right corner position of the display range of the same (150 dots along the X axis and 19 dots along the Y axis, from the origin). Similarly, coordinates “(0, 20)-(150, 39)” are set such that they are associated with the menu command of “Primary Node”. Coordinates “(0, 40)-(150, 59) are set in a manner associated with the menu command of “Secondary Node”.

The column of “Function Tutorial Message” stores character strings which are to be displayed by popup help when menu commands are selectable, such that they are associated with the respective menu commands. The FIG. 6 example stores a character string “Forms Representative IP Address object as an object hereunder.” in a manner associated with the menu command of “Representative IP Address”. A character string “Forms Primary Node object as an object hereunder.” is set in a manner associated with the menu command of “Primary Node”, and a character string “Forms Secondary node object as an object hereunder.” is set in a manner associated with the menu command of “Secondary Node”.

The column of “Selection-Permitting Condition” stores conditions for making menu commands selectable (selection-permitting conditions) in a manner associated with the menu commands. It is possible to set a plurality of selection-permitting conditions for one menu command. Further, there are menu commands without any selection-permitting conditions set thereto. In the FIG. 6 example, selection-permitting conditions “Primary Node object exists.” and “Secondary Node object exists.” are set in a manner associated with the menu command of “Representative IP Address”, whereas there are no selection-permitting conditions set to, i.e. associated with the menu commands “Primary Node” And “Secondary Node”.

Although in the FIG. 6 example, the selection-permitting conditions are represented in sentences, actually, they are each set as a routine for determining a selection-permitting condition. For instance, in the case of the selection-permitting condition “Primary Node object exists.”, a function for inquiring whether or not the primary node exists is defined. In this case, the selection-permitting condition is that the returned value of the function is a value designating the presence of the primary node (“truth”, for instance).

The column of “Selectability State (Dynamic Change)” stores, in a manner associated with each selection-permitting condition, information concerning whether or not the selection-permitting condition is satisfied. If the selection-permitting condition is satisfied, “Selectable” is set in the column of “Selectability State (Dynamic Change)”, whereas if the same is not satisfied, “Non-Selectable” is set in the column. In the FIG. 6 example, the selectability state of “Non-Selectable” is set in a manner associated with the selection-permitting condition “Primary Node object exists.” for the menu command of “Representative IP Address”, and the selectability state of “Non-Selectable” is set in a manner associated with the selection-permitting condition “Secondary Node object exists.”. The selectability state of “Selectable” is set for each of the menu commands “Primary Node” and “Secondary Node” since there is no selection-permitting condition set therefor.

The column of “Input aid message” stores, in a manner associated with selection-permitting conditions for menu commands, respective character strings each of which should be displayed by popup help when a corresponding menu commands is unselectable. In the FIG. 6 example, a character strings “To form Representative IP Address object, it is necessary to form Primary Node object in advance.” is set in a manner associated with the selection-permitting condition “Primary Node object exists.” for the menu command of “Representative IP Address”. Further, a character string “To form Representative IP Address object, it is necessary to form Secondary Node object in advance.” is set in a manner associated with the selection-permitting condition “Secondary Node object exists.” for the menu command of “Representative IP Address”. No input aid message is set for each of the menu commands “Primary Node” and “Secondary Node” since there is no selection-permitting condition set therefor.

The column of “Activation Action” stores, in a manner associated with each selection-permitting condition for each menu command, information (activation action) which specifies a screen used for carrying out an operation for satisfying the selection-permitting condition. In the FIG. 6 example, the activation action of “Primary Node Object-Forming Screen” is set in a manner associated with the selection-permitting condition “Primary Node object exists.” for the menu command of “Representative IP Address”. Similarly, the activation action of “Secondary Node Object-Forming Screen” is set in a manner associated with the selection-permitting condition “Secondary Node object exists.” for the menu command of “Representative IP Address”. No activation action is set for each of the menu commands “Primary Node” and “Secondary Node” since there is no selection-permitting condition set therefor.

Although in the FIG. 6 example, the names of configuration screens to be displayed are shown in the column of “Activation Action”, actually, there are set instructions for activating the configuration screens to be displayed.

In the client computer 100 constructed as above, a message display process is carried out for aiding user's operations. In the following, a procedure of operations of the message display process will be described.

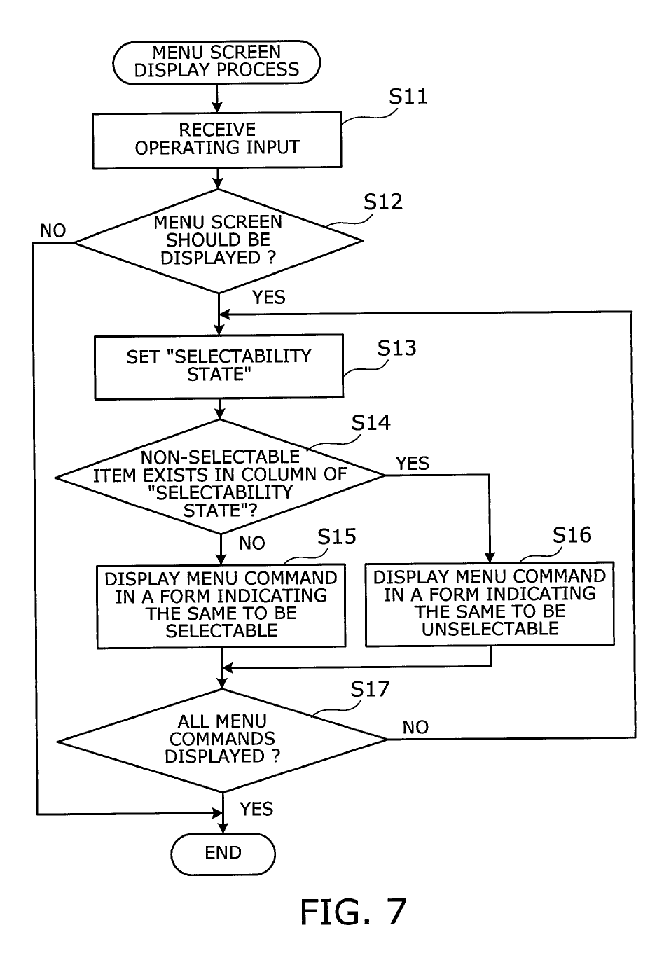

FIG. 7 is a flowchart showing a procedure of operations for carrying out a menu screen display process. Hereafter, the process shown in FIG. 7 will be described in the order of steps.

[Step S11] The menu screen display control section 121c receives information entered by an operating input via the input device 12a, by way of the user interface 110.

[Step S12] The menu screen display control section 121c determines whether or not the information entered by the operating input is an instruction for displaying a menu screen. More specifically, the menu screen display control section 121c determines whether or not the operating input is one effected by a predetermined operation (e.g. a click of the right button of the mouse 13). If the operating input is carried out by the predetermined operation, the menu screen display control section 121c obtains the coordinates of the pointer from the pointer coordinate-obtaining section 121b, and then determines whether or not a menu screen is defined for an object corresponding to the coordinates. If the menu screen is defined, it is determined that the menu screen is to be displayed, and the program proceeds to a step S13, whereas if no menu screen is defined, it is determined that no menu screen is to be displayed, followed by terminating the menu screen display process.

[Step S13] The menu screen display control section 121c selects one of the menu commands in the menu screen to be displayed, and requests the selection permission/inhibition-determining section 121d to determine whether or not the menu command is selectable. The selection permission/inhibition-determining section 121d checks the present settings of parameters and determines whether or not a selection-permitting condition corresponding thereto stored in the menu management table 121a is satisfied. Then, the selection permission/inhibition-determining 121d sets the result of the determination in the column of “Selectability State” of the menu management table 121a. If the selection-permitting condition is satisfied, “Selectable” is set, whereas if the selection-permitting condition is not satisfied, “Non-Selectable” is set.

[Step S14] The menu screen display control section 121c determines whether or not the menu command to be displayed has “Non-Selectable” set to any of the box(es) of the selectability state. If there is “Non-Selectable” set therein, the program proceeds to a step S16. If no “Non-Selectable” is set therein, the program proceeds to a step S15.

[Step S15] The menu screen display control section 121c displays the menu command in a form indicating that the menu command is selectable (in a clear form). For instance, the menu command is displayed in black letters on a gray background. After that, the program proceeds to a step S17.

[Step S16] The menu screen display control section 121c displays the menu command in a form indicating that the menu command is unselectable (in an unclear form). For instance, the menu command is displayed on a gray background in gray letters darker than the background.

[Step S17] The menu screen display control section 121c determines whether or not all the menu commands to be displayed in the menu screen have been displayed. If all the menu commands have been displayed, the menu screen display process is terminated, whereas if there is any menu command which is not yet displayed, the program returns to the step S13.

The menu screen is thus displayed. The displayed menu screen contains a plurality of menu commands, with selectable ones being displayed in a clear form and unselectable ones being displayed in an unclear form. In this state, if the mouse cursor is moved onto a menu command which the user desires to execute, the message display process is carried out.

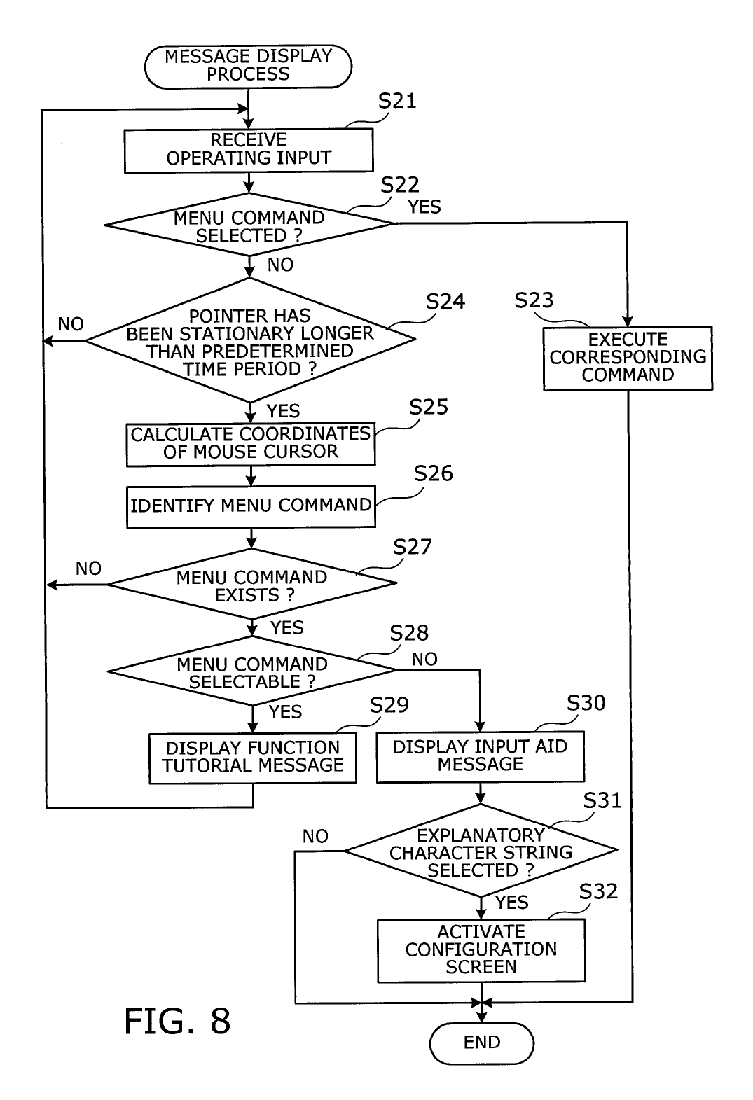

FIG. 8 is a flowchart showing a procedure of operations of the message display process. In the following, the procedure of operations of the process shown in FIG. 8 will be described in the order of steps. It should be noted that the following process is executed during a time period over which a menu screen is displayed and the control thereof is active (i.e. the menu screen is in a usable state). When the other processing functions are made active by the OS, the menu screen is cleared from the display screen of the display device 11a and at the same time the process described hereafter is also terminated.

[Step S21] The user interface 110 receives an operating input from the input device 12a, and passes information entered by the operating inputs to the server management section 120. For instance, when an operating input for moving the mouse pointer is performed, the position information of the mouse pointer is passed to the pointer coordinate-obtaining section 121b. Further, if an operating input for executing the menu command (e.g. a click of the left button of the mouse) is carried out when the mouse pointer is located on the menu, information of the operation is passed to the configuration function-activating section 121f.

[Step S22] The configuration function-activating section 121f determines whether or not a request for executing a menu command has been input, based on whether or not information indicative of an operating input for executing the menu command has been received from the user interface 110. If the request for executing the menu command has been received, the program exceeds to a step S23, whereas if the request has not been received, the program proceeds to a step S24.

[Step S23] The configuration function-activating section 121f obtains the present coordinates of the pointer from the pointer coordinate-obtaining section 121b, identifies the menu command indicated by the pointer in the menu screen being displayed, based on the coordinates of the pointer, and passes the execution request of the menu command to the process execution section 122. Responsive to the execution request, the process execution section 122 carries out a process designated by the menu command. For instance, an information-configuration screen is displayed in the screen of the display device 11a, followed by terminating the process.

[Step S24] The pointer coordinate-obtaining section 121b determines whether or not the pointer has been stationary or fixed longer than a predetermined time period. If the pointer has been stationary longer than the predetermined time period, the program proceeds to a step S25, whereas if not, the program returns to the step S21.

[Step S25] In the case where the pointer has been stationary longer than the predetermined time period, the pointer coordinate-obtaining section 121b calculates the coordinates of the pointer and passes the coordinates to the message display section 121e.

[Step S26] The message display section 121e looks up the menu management table 121a and identifies the menu command displayed at the position of the coordinates of the pointer.

[Step S27] The message display section 121e determines whether or not the menu command could be identified by the processing performed at the step S26, that is, whether or not the menu command exists at the position of the coordinates of the pointer. If the menu command exists, the program proceeds to a step S28, whereas if not, the program returns to the step S21.

The menu command is provisionally selected by the above steps S24 to S27.

[Step S28] The message display section 121e determines whether or not the menu command provisionally selected is selectable. Whether or not the menu command is selectable can be determined by looking up the column of “Selectability State” of the menu management table 121a. If the selectability state of the menu command provisionally selected is “Selectable”, the menu command is selectable, whereas if the selectability state of the menu command is “Non-Selectable”, the menu command is unselectable. If the menu command is selectable, the program proceeds to a step S29, whereas if the menu command is unselectable, the program proceeds to a step S30.

[Step S29] The message display section 121e looks up the column of “Function Tutorial Message” of the menu management table 121a, and causes the display device 11a to display a function tutorial message corresponding to the menu command provisionally selected. The function tutorial message is displayed by popup help at a location close to the displayed menu command. Then, the program proceeds to the step S21. It should be noted that the function tutorial message displayed is cleared from the screen when any operating input is received at the step S21.

[Step S30] The message display section 121e looks up the column of “Input aid message” of the menu management table 121a, to cause the display device 11a to display an input aid message corresponding to the menu command provisionally selected. The input aid message is displayed by popup help at a location close to the displayed menu command. It should be noted that the input aid message displayed is cleared from the screen when any operating input is received thereafter.

[Step S31] The configuration function-activating section 121f determines whether or not the input aid message displayed is selected. More specifically, if the user carries out an operating input for selecting the input aid message (e.g. by depressing the right button of the mouse in a state of the pointer being placed on the displayed input aid message), the information by the operating input is transmitted to the configuration function-activating section 121f via the user interface 110. It should be noted that the input aid message is considered to have been selected not only when the input aid message is selected but also when a corresponding menu command is selected while the input aid message is being displayed.

[Step S32] The configuration function-activating section 121f causes the display device 11a to display a corresponding configuration screen when the input aid message is selected. More specifically, when the input aid message is selected, the configuration function-activating section 121f looks up the column of “Activation Action” of a menu command corresponding to the selected input aid message, in the menu management table 121a. The configuration function-activating section 121f outputs a request for an activation action set in the column of “Activation Action” to the process execution section 122. This causes the process execution section 122 to execute the activation action.

For instance, if the activation action is “Primary Node Object-Forming Screen”, “Primary Node Object-Forming Screen” display process is carried out by the process execution section 122. As a result, the Primary Node object-forming screen is displayed on the display device 11a, followed by terminating the message display process.

As described above, if an unselectable menu command is provisionally selected by the pointer, an input aid message associated therewith is displayed. The input aid message shows a configuration required for making the provisionally selected menu command selectable. Further, if the input aid message displayed is selected by the user, a configuration screen for making the provisionally selected menu command selectable is displayed. Thus, the user is aided in performing operating inputs.

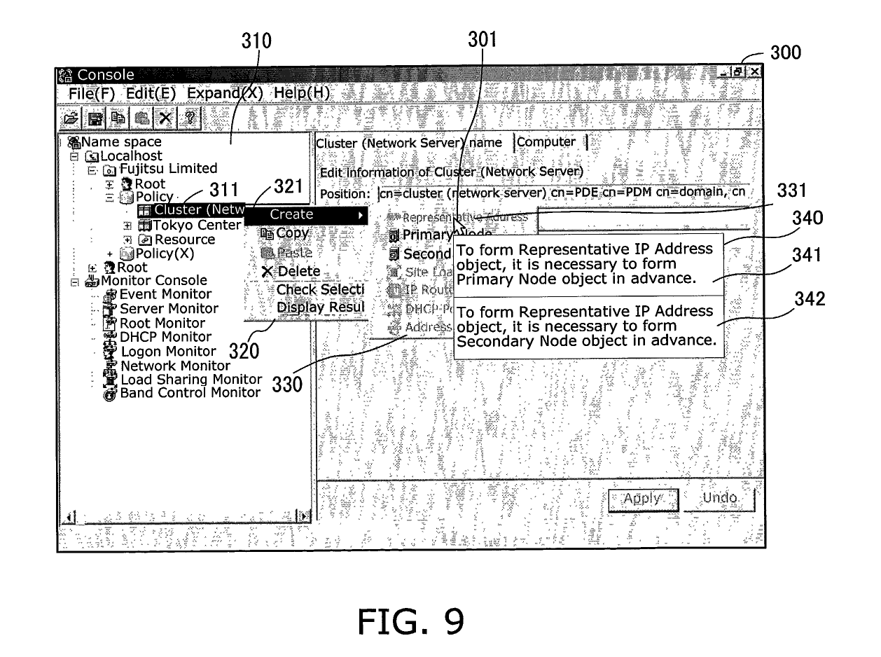

In the following, an example of screens switched when operating input aid messages are displayed will be described with reference to FIGS. 9 to 12.

FIG. 9 shows a server management screen with menu screens being displayed therein. The server management screen 300 is used for carrying out an operating input to the server management section 120.

The server management screen 300 is provided with a data structure display block 310 which displays the names of controllable servers and objects that can be set in the servers, in their hierarchical structure. When one of the objects displayed in the data structure display block 310 is selected, a corresponding menu screen is displayed. In the example illustrated in FIG. 9, an object 311 of “Cluster (Network Server)” is selected, and a menu screen 320 is displayed.

In the menu screen 320 are displayed respective menu commands of processes which can be executed concerning the corresponding object 311. When one of the menu commands displayed is selected, a corresponding process is executed, or another menu screen corresponding thereto is displayed. In the example illustrated in FIG. 9, a menu command 321 of “Create” is selected, and another menu screen 330 corresponding thereto is displayed.

In the menu screen 330, there are displayed a plurality of menu commands associated with the selected menu command 321. Of the menu commands displayed in the menu screen 330, selectable ones are displayed in a clear form while unselectable ones are displayed in an unclear form by being grayed out. For instance, a menu command 331 of “Representative Address” is grayed out since it is unselectable.

Now, to set a representative address, the user is required to make the menu command 331 of “Representative Address” selectable. Therefore, the user operates the mouse 13 to move the pointer 301 to the position of the menu command 331 of “Representative Address”, whereupon the menu command 331 is provisionally selected, and input aid messages 341, 342 are displayed by the popup help 340 at a location close to the menu command 331 (below and to the right thereof in the FIG. 9 example). In the illustrated example, two selection-permitting conditions are assumed to be in non-selectable state (see FIG. 6), and the input aid messages 341, 342 corresponding to the respective selection-permitting conditions are displayed. The input aid message 341 notifies the user “To form Representative IP Address object, it is necessary to form Primary Node object in advance.” The input aid message 342 notifies the user “To form Representative IP Address object, it is necessary to form Secondary Node object in advance.”

The user can understand what he should do to make the menu command 331 of “Representative Address” selectable by reading the input aid messages 341, 342. Then, when the user selects the input aid messages 341, 342, a configuration screen for making the menu command 331 of “Representative Address” selectable is displayed in the server management screen 300.

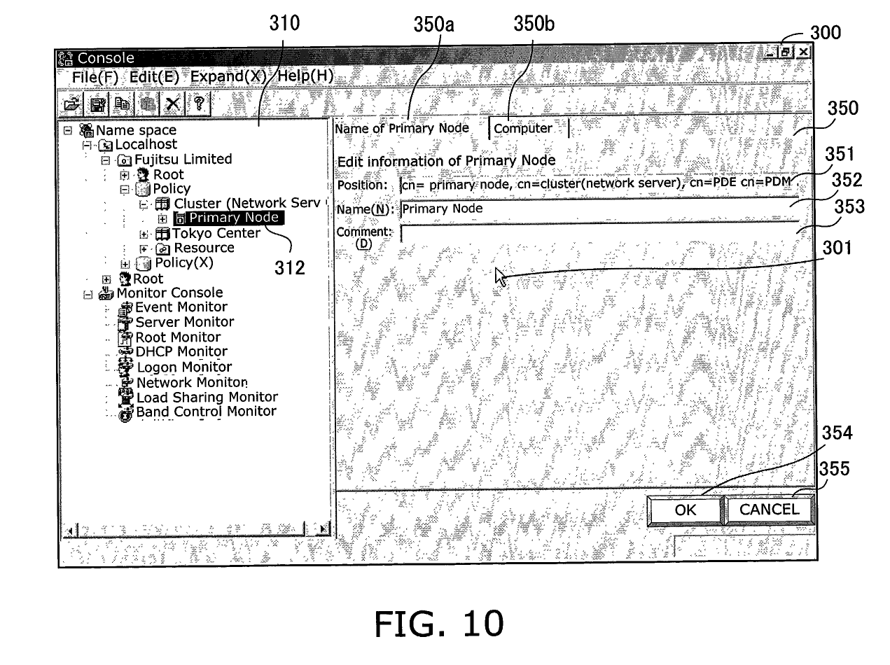

FIG. 10 shows an example of the server management screen 300 which has a primary node-setting screen displayed therein. In the data structure display block 310 of the server management screen 300, an object 312 of Primary Node is displayed in a selected state, and the primary node-setting screen 350 is displayed on the right side of the data structure display block 310. The primary node-setting screen 350 has a tab 350a of “Name of Primary Node” and a tab 350b of “Computer” arranged therein. By inputting required information to entry items set in the respective tabs 350a, 350b, the primary node can be set.

For instance, when the user selects the tab 350a of “Name of Primary Node”, a position display area 351, a name input area 352, a comment input area 353, an “OK” button 354, and a “Cancel” button 355 are displayed in the primary node-setting screen 350. In the position display area 351, information of the logical position of the primary node on the network, is displayed. The name of the primary node can be input to the name input area 352. A comment to be set for the primary node can be input to the comment input area 353.

The “OK” button 354 is a button to be clicked when the information input on the primary node-setting screen 350 is finally determined. When the “OK” button 354 is clicked, the information input on the primary node-setting screen 350 is set as information concerning the primary node. The “Cancel” button 355 is used for closing the primary node-setting screen 350 without finally determining the information input on the primary node-setting screen 350.

When the user inputs the information and clicks the “OK” button 354 on the primary node-setting screen 350, a secondary node-setting screen is displayed.

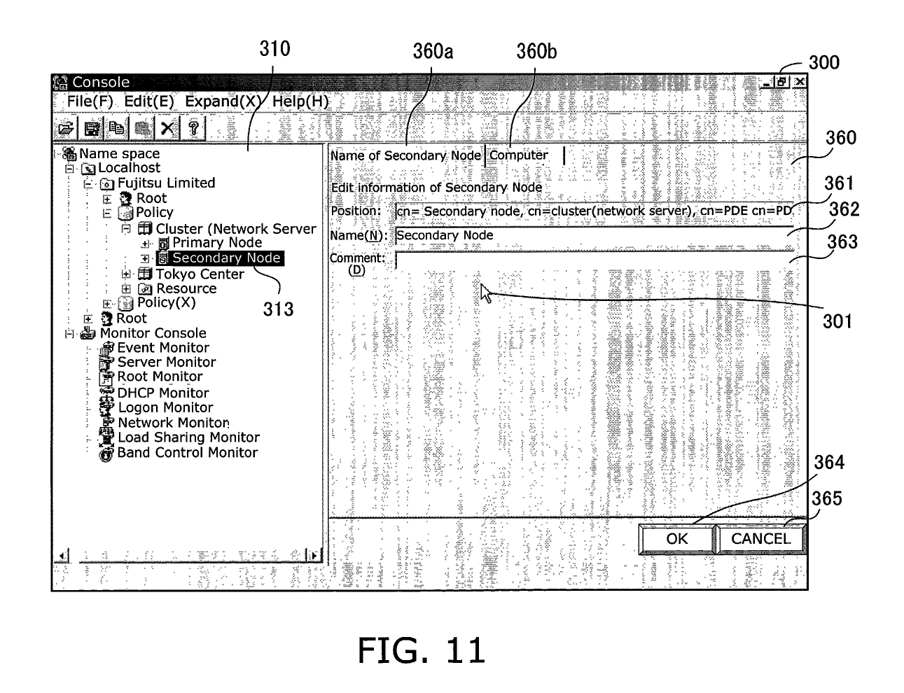

FIG. 11 shows an example of the server management screen 300 which has a secondary node-setting screen displayed therein. In the data structure display block 310 of the server management screen 300, an object 313 of Secondary Node is displayed in a selected state, and the secondary node-setting screen 360 is displayed on the right side of the data structure display block 310. The secondary node-setting screen 360 has a tab 360a of “Name of Secondary Node” and a tab 360b of “Computer” arranged therein. By inputting required information to the entry items set in the respective tabs 360a, 360b, it is possible to set the secondary node.

For instance, when the user selects the tab 360a of “Name of Secondary Node”, a position display area 361, a name input area 362, a comment input area 363, an “OK” button 364, and a “Cancel” button 365 are displayed in the secondary node-setting screen 360. In the position display area 361, information of the logical position of the secondary node on the network is displayed. The name of the secondary node can be input to the name input area 362. A comment to be set for the secondary node can be input to the comment input area 363.

The “OK” button 364 is a button to be clicked when the information input on the secondary node-setting screen 360 is finally determined. When the “OK” button 364 is clicked, the information input on the secondary node-setting screen 360 is set as information concerning the secondary node. The “Cancel” button 365 is used for closing the secondary node-setting screen 360 without finally determining the information input on the secondary node-setting screen 360.

When the user inputs information and clicks the “OK” button 364 on the secondary node-setting screen 360, it becomes possible to set the representative address. More specifically, it becomes possible to select the menu command 331 of “Representative Address” on the menu screen 330 in the server management screen 300 shown in FIG. 9. Therefore, when the “OK” button 364 is clicked on the secondary node-setting screen 360, a request for activating a process corresponding to the menu command 331 is made by the configuration function-activating section 121f, whereby a representative address-setting function is executed by the process execution section 122. As a result, a representative address-setting screen is displayed on the display device 11a.

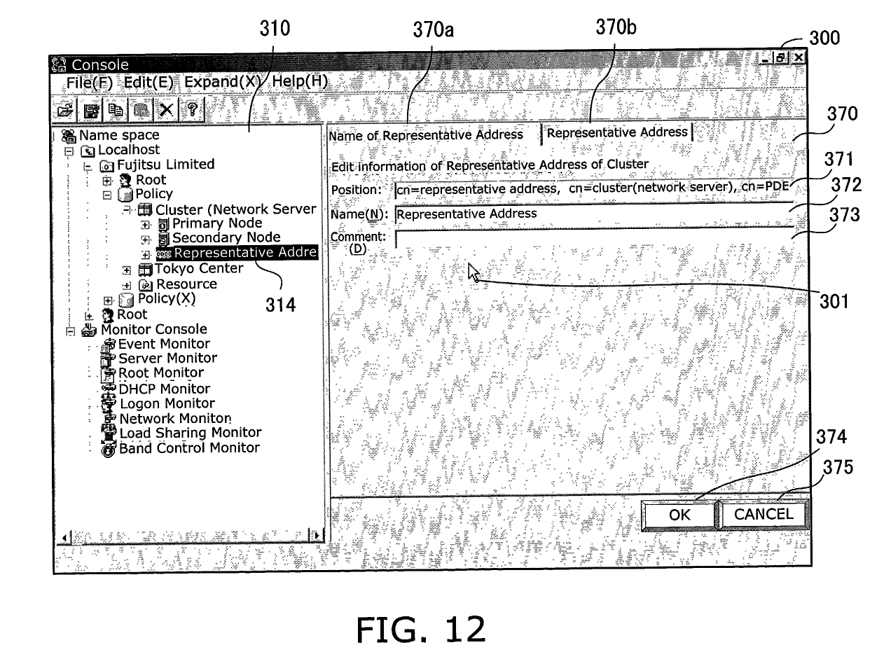

FIG. 12 shows an example of the server management screen 300 which has a representative address-setting screen displayed therein. In the data structure display block 310 of the server management screen 300, an object 314 of Representative Address is displayed in a selected state, and the representative address-setting screen 370 is displayed on the right side of the data structure display block 310. The representative address-setting screen 370 is provided with a tab 370a of “Name of Representative Address” and a tab 370b of “Representative Address”. By inputting required information to the entry items set in the respective tabs 370a, 370b, it is possible to set the representative address.

For instance, when the user selects the tab 370a of “Name of Representative Address”, a position display area 371, a name input area 372, a comment input area 373, an “OK” button 374, and a “Cancel” button 375 are displayed in the representative address-setting screen 370. In the position display area 371, information of the logical position of the representative address on the network is displayed. The name of the representative address can be input to the name input area 372. A comment to be set for the representative address can be input to the comment input area 373.

The “OK” button 374 is a button to be clicked when the information input on the representative address-setting screen 370 is finally determined. When the “OK” button 374 is clicked, the information input on the representative address-setting screen 370 is set as information concerning the representative address. The “Cancel” button 375 is used for closing the representative address-setting screen 370 without finally determining the information input on the representative address-setting screen 370.

Thus, when the input aid messages 341, 342 are selected, the configuration screen for making the menu command of “Representative Address” selectable is displayed, and then the representative address-setting screen 370 is displayed.

As described heretofore, according to the embodiment of the invention, when a menu command is unselectable, a message (input aid message) notifying the user of a process required for making the menu command selectable is displayed on the screen only by moving the pointer onto the menu command. This makes it possible to save the user from taking the trouble of consulting manuals or carrying out trial-and-error operations so as to make the menu command selectable, which enhances the operability of the message display apparatus.

Moreover, when the input aid message displayed is selected, a process for making the menu command selectable is activated. This saves the user from taking the trouble of looking for another menu command to be selected for changing the present settings.

Furthermore, the system is configured such that when the menu command is made selectable after termination of the process for making the menu command selectable, a command associated with the menu command is executed, so that there is no need to carry out again the operation for selecting the menu command. This contributes to the enhanced operability of the system.

Although in the above embodiment, when there are a plurality of unsatisfied selection-permitting conditions, it is assumed that respective input aid messages set for the conditions are displayed, this is not limitative, but a common input aid message may be displayed. For instance, in the FIG. 9 example, an input aid message “To form Representative Address, it is necessary to form Primary Node and Secondary Node in advance under the cluster.” may be displayed.

In the above embodiment, the process for displaying input aid messages corresponding to a menu command has been described. Similarly, also when an icon is selected, it is possible to display an input aid message. Further, when an object which can be changed in its selection-permitting condition is selected (or provisionally selected), it is also possible to display a reason why it is unselectable, as an input aid message.

Further, although in the above embodiment, some examples of the selection-permitting conditions are described, this is not limitative, but various conditions other than the examples can be contemplated as selection-permitting conditions. For instance, in the case of a multi-user system, it is sometimes set as a selection-permitting condition that conditions concerning the user's privilege are satisfied. More specifically, for instance, there can be a case in which a user logged in by a general users' account attempts to select a menu command which can be executed only by a user logged in by a super users' account. In this case, for instance, an input aid message that “It is necessary to login again by a super user's account.” is displayed. If the input aid message is selected, a system login screen is displayed, for instance.

It should be noted that the above-mentioned processing capabilities can be implemented by a computer. In this case, a program is provided which describes details of processing executed by the functions which the server management section 120 should have. The processing capabilities are realized on the computer by causing the computer to execute the program. The program having the details of the processing written therein can be recorded in a computer-readable recording medium. The computer-readable recording media include a magnetic recording device, an optical disk, a magneto-optical recording medium and a semiconductor memory. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. Further, the magneto-optical recording medium may be an MO (Magneto-Optical disk) or the like.

To make this program available on the market, for instance, it can be stored in a portable recording medium, such as a DVD or CD-ROM, for sale. Further, the program can be stored in a storage device of a server computer connected to a network, and transferred from the server computer to other computers via the network.

When the program is executed by a computer, the program stored in a portable recording medium or transferred from the server computer is stored into a storage device of the computer. The computer reads the program from the storage device of its own and executes processing based on the program. The computer can also read the program directly from the portable recording medium and execute processing based on the program. Further, whenever a program is transferred from the server computer, the computer also can execute processing based on the received program.

As described above, according to the present invention, when an object displayed on a computer is selected by an operating input, if an execution-permitting condition therefor is not satisfied, an input aid message is displayed, and therefore it is possible to inform the user of a reason why the object cannot be executed. As a result, when it is impossible to carry out an object, the user can quickly know the reason, whereby the productivity is enhanced.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A message display program for displaying a message on a screen,
the program causing a computer to execute the processes of:
looking up an execution-permitting condition, when an object associated with a predetermined command is displayed and selected by an operating input, the object being associated beforehand with the execution-permitting condition which is a precondition for executing the command, and determining whether or not the execution-permitting condition is satisfied; and
displaying an input aid message associated beforehand with the execution-permitting condition when it is determined that the execution-permitting condition is not satisfied.

2. The message display program according to claim 1, wherein the input aid message is formed by a character string which describes an operation required for satisfying the execution-permitting condition.

3. The message display program according to claim 1, wherein a function tutorial message associated with the command beforehand is displayed when it is determined that the execution-permitting condition is satisfied.

4. The message display program according to claim 1, wherein the object is a menu command which is displayed in a menu screen.

5. The message display program according to claim 1, wherein a process required for satisfying the execution-permitting condition is activated after the input aid message is displayed.

6. The message display program according to claim 5, wherein the process is activated when the input aid message is selected after the input aid message is displayed.

7. The message display program according to claim 5, wherein the command is executed when the activated process is normally terminated.

8. The message display program according to claim 5, wherein the process is a process for setting information required for executing the command.

9. A message display apparatus for displaying a message on a screen, comprising:
an object management table defining a correspondence between each object associated with a respective predetermined command and an execution-permitting condition which is a precondition for executing the command, and a correspondence between the execution-permitting condition and an input aid message;
determination means which, when the object displayed is selected by an operating input, looks up said object management table to determine whether or not the execution-permitting condition associated with the selected object is satisfied; and
display means for displaying the input aid message associated with the execution-permitting condition in said object management table when it is determined by said determination means that the execution-permitting condition is not satisfied.

10. The message display apparatus according to claim 9, wherein the input aid message is formed by a character string which describes an operation required for satisfying the execution-permitting condition.

11. The message display apparatus according to claim 9, wherein a function tutorial message associated with the command beforehand is displayed when it is determined that the execution-permitting condition is satisfied.

12. The message display apparatus according to claim 9, wherein the object is a menu command which is displayed in a menu screen.

13. The message display apparatus according to claim 9, further including activation means for activating a process required for satisfying the execution-permitting condition after the input aid message is displayed.

14. The message display apparatus according to claim 13, wherein said activation means activates the process when the input aid message is selected after the input aid message is displayed.

15. The message display apparatus according to claim 13, wherein said activation means causes the command to be executed when the activated process is normally terminated.

16. The message display apparatus according to claim 13, wherein said activation means activates a process for setting information required for executing the command, as the process.

17. A message display method for displaying a message on a screen,
the method comprising the steps of:
looking up an execution-permitting condition, when an object associated with a predetermined command is displayed and selected by an operating input, the object being associated beforehand with the execution-permitting condition which is a precondition for executing the command, and determining whether or not the execution-permitting condition is satisfied; and
displaying an input aid message associated beforehand with the execution-permitting condition when it is determined that the execution-permitting condition is not satisfied.

18. A computer-readable recording medium recording a message display program for displaying a message on a screen,
the program causing a computer to execute the processes of:
looking up an execution-permitting condition, when an object associated with a predetermined command is displayed and selected by an operating input, the object being associated beforehand with the execution-permitting condition which is a precondition for executing the command, and determining whether or not the execution-permitting condition is satisfied; and
displaying an input aid message associated beforehand with the execution-permitting condition when it is determined that the execution-permitting condition is not satisfied.
